(19) United States
(12) Patent Application Publication
(10) Pub. No.: US 2018/0292803 A1
(43) Pub. Date: Oct. 11, 2018

(54) SYSTEM AND METHOD FOR MACHINE WORKPIECE ALIGNMENT

(71) Applicant: Kugar Inc., San Francisco, CA (US)

(72) Inventors: Gary Stanley Kurek, San Francisco, CA (US); Christian Mackin, Aliso Viejo, CA (US)

(21) Appl. No.: 15/947,349

(22) Filed: Apr. 6, 2018

Related U.S. Application Data
(60) Provisional application No. 62/482,411, filed on Apr. 6, 2017.

(51) Int. Cl. G05B 19/401; G05B 19/418; G05B 19/402

(52) U.S. Cl. CPC G05B 19/401; G05B 19/41805; G05B 2219/45055; G05B 2219/37008; G05B 19/402

(57) ABSTRACT

A system and method for calibrating a manufacturing machine that includes a leveling device including a machine base interface to a manufacturing machine, a support system that comprises of a set of linearly actuating supports, a workpiece interface, and wherein actuation of supports collectively adjusts the orientation of the workpiece interface with two degrees of angular freedom; and a calibration system with sensors configured to measure the orientation of the workpiece interface.

### CROSS-REFERENCE TO RELATED APPLICATIONS

This Application claims the benefit of U.S. Provisional Application No. 62/482,411, filed on 6 Apr. 2017, which is incorporated in its entirety by this reference.

### TECHNICAL FIELD

This invention relates generally to the field of machine calibration, and more specifically to a new and useful system and method for machine workpiece alignment.

### BACKGROUND

In the field of industrial manufacturing, machine maintenance is a crucial part to reliable manufacturing and in maintaining productivity. On large industrial machines, like a CNC (Computer Numerically Controlled) mill, it is very important that the machine remain square, or for the surface representing one axis (in an x, y, z, or multiple other configurations) to be at an exact angle, usually perpendicular, to another axis in order to properly perform the functions of producing high precision metal parts under high forces, in an additive or subtractive method of production.

CNC machines, and other large industrial machines that must produce high precision products under extreme force, are often built on a very large bases, usually a several thousand pound solid metal casting, to ensure rigidity, and to minimize vibration and chattering during operation. These large bases, once cast, are then precision milled to be flat, usually within 10 thousandths of an inch, as casting alone cannot achieve the precision tolerances required for the machine. This requires putting the CNC base casting into an even larger milling center, in order to mill the very large surface to be almost perfectly flat.

Once the casting has been precision milled on its applicable surfaces, very high precision linear rail components that allow the machine's work tables (to hold parts), and spindle assemblies (to cut a material) to move along their axis of motion, are mounted to the base casting, and adjusted to hold a tolerance of usually less than ten thousands of an inch to ensure proper performance. Adjusting these rail components correctly is one of the most important parts of ensuring the performance of a large industrial machine like a CNC.

Today, these rail components on CNC machines regularly fall out of alignment. As of yet there are not many efficient ways of calibrating these machines, which leads to infrequent and time consuming intervals where the machines are adjusted. CNC machines are adjusted most often only every 6 or 12 months depending on machine use and other factors, as adjustment requires a significant dismantling of the machine to access the many screws and bolts that hold the linear rails in place. This is a very expensive and time consuming endeavor, which puts the industrial machine out of commission for often extended periods of time, leading lost productivity and profits for a business.

Because of the time and resource constraints for the calibration process, machines are often operated for long periods where the machine is partially out of calibration but not enough to warrant recalibration. This can impact the effective precision of the machine which may result in slower machining speeds and/or less precise tolerances. Even if a calibrated machine could achieve tolerances, practically speaking, one could not rely on these tolerances since for several months the machine can be in a minor state of misalignment.

There is no tried and true scientific process in fine-tuning these rail components. An experienced technician will often just loosen or remove the dozens of bolts that hold the rail components to the casting, and slowly loosen and adjust the many bolts across the entire machine, while also taking frequent measurements, until the rails are realigned within the desired tolerance. This process is not consistent across all industrial machines, and not even across products from the same company or category, making adjustments even a greater ordeal. This process often takes days to complete thereby impacting productivity. Furthermore, access to an experienced technician may be limited and alignment of the machine may be highly variable depending greatly on the skill of the technician. Thus, there is a need in the machine calibration field to create a new and useful system and method for machine worktable alignment. This invention provides such a new and useful system and method.

### BRIEF DESCRIPTION OF THE FIGURES

FIG. 1 is a schematic representation of the system in use with a machine;

FIG. 2 is a schematic representation of the system with two leveling devices;

FIG. 3 is a schematic of the system where the base of the machine is built by a series of modular blocks;

FIG. 4 is one schematic representation of the leveling device of the system;

FIG. 5 and FIG. 6 are schematic representations of a rail system manufacturing machine;

FIG. 7 is one schematic of an actuating support with a sensor.

FIG. 8 and FIG. 9 are flowchart representations of methods of preferred embodiments.

### DESCRIPTION OF THE EMBODIMENTS

The following description of the embodiments of the invention is not intended to limit the invention to these embodiments but rather to enable a person skilled in the art to make and use this invention.

### DESCRIPTION OF THE EMBODIMENTS

The following description of the embodiments of the invention is not intended to limit the invention to these embodiments but rather to enable a person skilled in the art to make and use this invention.

### 1. Overview

A system and method of workpiece alignment for manufacturing of a preferred embodiment functions to significantly enhance the calibration capabilities of manufacturing machinery. The system and method preferably employ the use of a set of adjustable supports mounted in between a machine base and a workpiece to modify alignment of a workpiece.

Rather than mounting rail system components (e.g., a worktable or machine tooling) directly to a machine base (e.g., a casting) through a manual process performed by a highly trained technician, the system and method integrates a leveling device as an additional layer of components between the rail system (or another machine component) and the machine base surface that the rail system would typically be mounted to. The rail system components are mounted to a workpiece interface that is mounted upon actuating supports that raise and lower (either by manual, motorized, or other forms of actuation) to adjust the exact angle of the work surfaces on the machine. In the case of a 3-axis CNC vertical milling center, or a Cartesian machine like a 3D printer, where the x and y axis surface are preferably substantially square and 90 degrees perpendicular to the z axis, both the x and y rail system table and z axis rail system table could be easily adjusted via the system and method proposed, and properly squared up to ensure calibrated machine performance.

The system and method preferably systematizes the calibration of an industrial manufacturing machine. In one variation, the system and method can be applied for manually actuation. In another variation, the system and method can be applied for automatic computer controlled actuation through a motor system or other suitable type of mechanism to drive actuation.

The system and method is preferably applied for industrial manufacturing machines such as vertical mills, horizontal mills, multi-axis CNC machines, laser cutters, water jet cutters, 3D printers, plotters, robotic arms and/or any suitable manufacturing machine that involves the precision alignment of one or more surfaces. Herein the system and method are primarily described as it can be used for the calibration of a workpiece or rail system. However, the system and method may alternatively be used for calibrating orientation of any suitable component mounted to a workpiece interface of the leveling device such as a machining tool, a robotic arm, or other suitable components of a manufacturing machine.

In one variation, the system and method are used for calibration of a single leveling device. The leveling device and the component coupled to the workpiece interface of the leveling device can be calibrated relative to an absolute reference frame, a machine reference frame (e.g., the machine base), a machining tool (e.g., to the center of the spindle of a vertical mill), or any suitable reference frame. In another variation, the system and method can be used for calibration of two or more leveling devices. In this variation, the two or more leveling devices may be calibrated relative to each other or another suitable reference frame. This calibration can be useful in counteracting various changes in machine alignment such as distortions or shifts in a machine component such as a rail system, warping of a machine base, movements of a fixtured piece subject to machine operations, and/or other factors. For example, a milling machine base may warp where the vertical column warps backwards and the horizontal base warps downwards in response to the forces experienced during machine processing.

As one potential benefit, the system and method preferably simplifies the calibration process. As will be discussed, the system and method can be used for manual calibration process or a computer controlled calibration process. In both scenarios, the ease of calibration is improved over the existing practice that involves dismantling of portions of a machine. The system and method can preferably be calibrated without significant dismantling of the machine. In some implementations, the system and method can be applied to calibrating a worktable surface in a matter of seconds or minutes as compared to hours or days.

Because the calibration process is simpler and ideally faster, calibration may be performed more frequently and regularly. Alignment could feasibly be adjusted for each job or even during a job. This can have numerous resulting benefits. With more frequent and regular calibrations, machines employing the system and method may provide more consistent performance capabilities. Machining tolerances of a machine may be effectively improved because the tolerance thresholds do not have to account for periods when the machine is partially out of alignment. Consistently maintaining the machine would also mean that products produced by the machining may also be less error prone and themselves need fewer future adjustments.

As another potential benefit, the system and method can preferably enable more consistent calibration by being a systematic sensor driven approach. The calibration process of the system and method is not dependent on the level of expertise of a specialized technician. Calibration is preferably substantially consistent between each calibration of one instantiation of the system and method. Calibration is additionally substantially consistent across multiple instantiations of the system and method. In high volume manufacturing facilities with many machines working in parallel, consistent calibration may be beneficial to performance.

As another potential benefit, the system and method can enable computer controlled calibration of machines. In enabling the capability for calibration to be controlled, calibration can even be more effectively automated and integrated into machine operation. For example, calibration can occur automatically in between jobs. In another example, calibration can be performed during use of a machine in real-time.

As yet another potential benefit, the design constraints that usually guided industrial machines towards heavy and rigid solid castings could possibly be reduced. The system and method can open up the use of less rigid machine bases that require higher tolerance maintained at all times. As described herein, the system and method may be used in combination with alternative machine bases such as a machine base constructed of a set of modular blocks.

As yet another potential benefit, maintaining the calibration of the machine may also mean less general “wear and tear” on machine components. This may increase the life span of many machine components and thus reduce the frequency of replacing machine components. This would again reduce both general cost of operation of the machine and increase productivity.

The system and method can offer many potential benefits to the field of manufacturing. Herein are listed a limited sample of benefits which is by no means an exhaustive list.

### 2. System

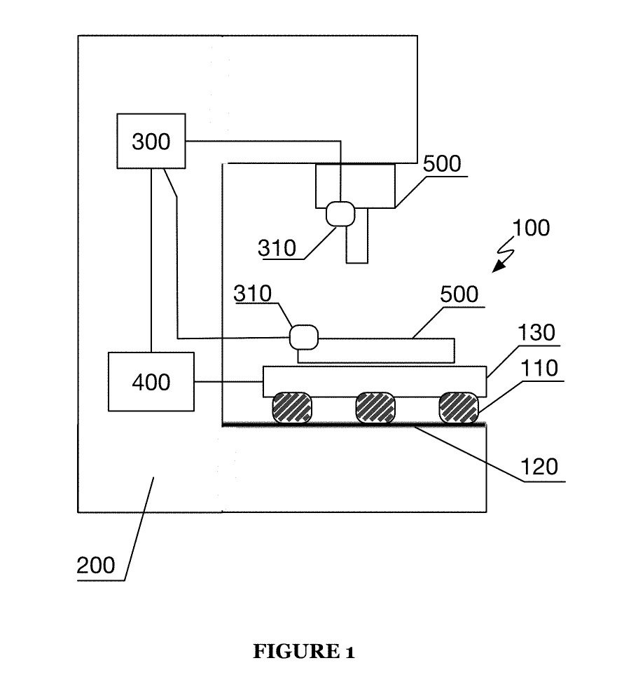

As shown in FIG. 1, a system for workpiece alignment of a preferred embodiment can include a manufacturing machine comprised of a leveling device 100 comprised of a support system no intermediately coupled to a machine base interface 120 and a workpiece interface 130; and a calibration system 300 configured to measure and calibrate the orientation of the workpiece interface 130. The calibration system 300 is preferably used to drive or direct the actuation of the leveling device 100 and thereby facilitates precise calibration of the workpiece interface 130 (and by extension coupled components 500 connected to the workpiece interface).

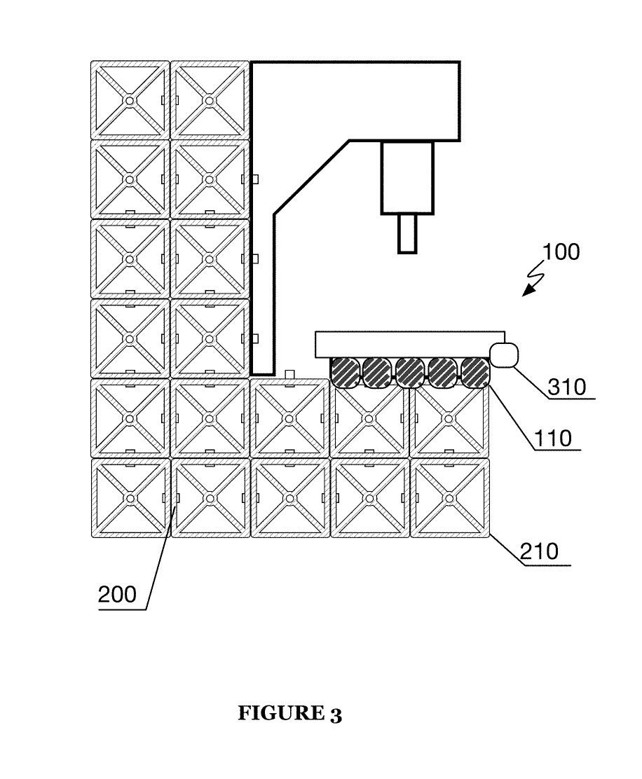

The leveling device 100 of a preferred embodiment functions to facilitate adjustment of orientation of a workpiece interface 130 and coupled components 500. The leveling device 100 is preferably used in connection with a manufacturing machine. In particular, the manufacturing machine is a precision machining tool such as a mill or lathe, but may alternatively be other types of manufacturing machines such as a robotic assembly/part manipulation system, electronic part handler, or any suitable type of equipment. In some variations the machine base 200 may be a component of the system. In other variations, the machine base 200 may be an external system with which the system may be used. For example, the system may be used to retrofit existing machines to enable calibration capabilities of the system. The machine base 200 plays a stability role in the system, e.g. provides a stable platform for operation and/or provides a controlled fixed position to align and/or calibrate the system or exterior components. The machine base 200 can be a solid cast metal base. Alternatively, the machine base 200 can use any suitable material or number of parts. As seen in FIG. 3, in one preferred example, the machine base 200 can be an assembled set of modular blocks 210 used to serve in place of a solid casting. The modular blocks 210 can be attached together to give the desired shape and size required for the base but serve as an alternative that is lighter, cheaper, and more customizable than a metal cast machine base 200.

The leveling device 100 preferably includes a machine base interface 120, that may function as a stable platform; a workpiece interface 130, that may function as an orientable object that may be coupled to an orientation-sensitive component of the manufacturing machine; and an actuating support system no, that functions to orient the workpiece.

The machine base interface 120 of a preferred embodiment functions to couple or connect the leveling device 100 to a portion of the manufacturing base 200. More specifically, the machine base interface 120 rigidly connects the machine base 200 to the support system no.

In one variation, the machine base interface 120 may be a mounting plate used to couple the machine base 200 to the support system 110 The mounting plate may be a single piece of solid, rigid material like a steel plate. A multi-part mounting plate may alternatively be used. In one variation, there may be multiple distinct mounting plates used for mounting to different subregions of the machine base 200. The size, shape, and location of the machine base 200 and support system fixture mechanisms may be adjusted and customized for the particular use case and/or type of machine. In one implementation, a mounting plate will preferably include a set of fixturing mechanisms where a subset of base fixture mechanisms and support system fixture mechanisms. The base fixture mechanisms functions as a coupling point that may be used to couple the machine base 200 to the mounting plate, and thereby the leveling device 100. For example, the mounting plate can be bolted to an exposed surface of the manufacturing base 200 through a series of machine fixture mechanisms like defined bolt through-holes. The support system fixture mechanisms function as coupling points that may be used to couple the mounting plate to one or more components of the support system 110. The support system fixturing mechanisms may more specifically be individual support fixture mechanisms such that individual actuating support 112 or static support 114 (described below) can be mounted at different locations. In one variation, the static support 114 may be integrated directly into the design of the machine base interface 120. Similarly, other parts of the support system 110 may be directly integrated with the mounting plate. For example, the machine base interface 120 and the support system 110 may be designed as a substantially single integrated component.

In another variation, the machine base interface 120 may be a set of fixturing mechanisms integrated into the support system 110 or other elements of the leveling device 100. The fixturing mechanism can be a set of bolt fastening mechanisms, but may alternatively be a latching mechanism or other suitable types of fixturing mechanisms. In one implementation, a set of actuating supports 112 and optionally static supports 114 can each include a set of bolt holes that can be used to bolt the actuating supports 112 and static supports 114 directly to a surface of the manufacturing base 200.

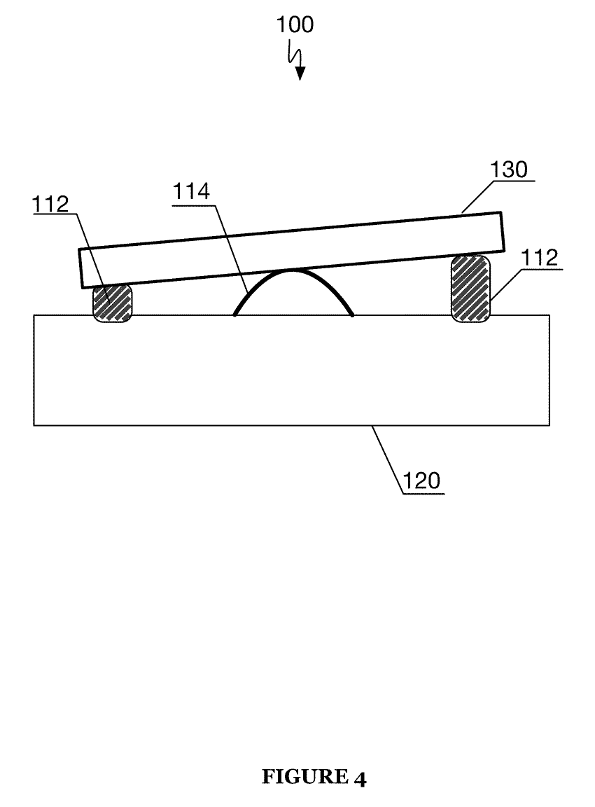

The support system 110 of a preferred embodiment functions to support, actuate, and/or move the workpiece interface 130, or any other object that is connected (directly or indirectly) to the support system 110. The support system 110 can preferably be actuated over a range of orientations. Within the range of the orientations, the support system 110 can preferably be precisely adjusted. Additionally, when in a set orientation, the support system 110 is preferably substantially rigid such that the orientation is maintained during various manufacturing or machining processes are applied to components coupled to the leveling device 100. As seen in FIG. 4, the support system 110 may include at least one linearly actuating support 112. The support system 110 may additionally include static supports 114 as shown in FIG. 4.

An actuating support 112 of a preferred embodiment functions to produce controlled movement in the support system 110. The actuating support 112 can affect a calibration adjustment point for the coupling between the machine base interface 120 and the workpiece interface 130. An actuating support 112 is preferably a component of the support system 110, wherein a single support system 110 may be comprised of multiple actuating supports 112. The actuating support 112 preferably offers actuation along at least one dimension. The actuation action preferably has a high level of precision in actuation to allow for fine tuning adjustments. In one preferable variation, rotation of an actuating support 112 may offer linear actuation of the actuating support 112. For example, the actuating support 112 can include a screw mechanism wherein rotating of a component of the actuating support 112 may cause the support length to increase or decrease. In some variations, the support may additionally or alternatively use other forms of actuation such that motion occurs in non-linear directions while linear actuation still occurs predominantly. For example, spiral wheel actuators may primarily alter the height of the workpiece interface 130 while simultaneously slightly displacing the workpiece interface 130 forwards or backwards. Alternative types of actuating supports 112 may also be used that additionally or alternatively offer rotational actuation or actuation along multiple axes. The actuating support 112 could produce actuation through a mechanical, hydraulic, pneumatic, magnetic, electromagnetic, or any other suitable mechanism that can be used in adjusting the alignment of the workpiece interface 130. Regardless of the method and direction of actuation, the actuating support 112 may be designed to give a high level of precision in displacement. In the example of the screw actuating support 112, the thread count per unit length of the screw may be very high, allowing the screw to be turned over wide angles to achieve small incremental linear actuation of the screw. As an added benefit of precision, the high thread density would also mean that less power would need to be generated (either manually or by machine) to raise the screw.

The actuating support 112 additionally includes an adjustment control mechanism. The adjustment control mechanism is preferably a mechanism through which the actuation position of the actuating support 112 can be changed. The adjustment control mechanism can be a manual control and/or computer-controlled mechanism. In one example of a manual control implementation, the adjustment control mechanism can be a tuning screw that can be rotated to increase or decrease the actuated position. The adjustment control mechanism may alternatively use any suitable mechanism and input design. The adjustment control mechanism is preferably easily accessible on the machine for manual calibration. For example, the adjustment control mechanism may be directed outward or otherwise exposed so that a worker can manually adjust the mechanism. Similarly, the adjustment control mechanism may include a controller extension so that the controller input can be positioned at a location removed from the actuating support 112. For example, a mechanical mechanism may translate the rotation of the tuning screw at an easily accessible control input to the adjustment control mechanism that affects the actuating support position.

The adjustment control mechanism could alternatively or additionally be computer controlled. The actuating support 112 could be actuated through controlled motor manipulation, pneumatics, hydraulics, magnetics, electromagnetic control, and/or any suitable mechanism for controlled actuation. Controlled actuating supports 112 can preferably be sent directives to alter actuation to different positions. The actuation position, the speed, and/or other aspects may be also controllable.

The actuating support 112 may additionally includes an encoder so that the actuated state can be detected and reported to a connected computing device.

Additionally, the actuating support 112 can include a meter that reports the current state of the actuating support 112. The current state of the actuating support 112 can include its current actuation position. The actuation position may be read relative to changes in actuation. The actuation position may alternatively be an absolute measurement relative to the actuating support 112. Additionally, the current state of the actuating support 112 may include stresses, support age, last maintenance date, and/or any other relevant data. The meter could be an analog meter but could alternatively be a digital meter that reports based on the current position/state reported through the encoder.

In addition to actuating support 112, the support system 110 may include static supports 114. A static support 114 functions as a structural support, i.e. supporting the workpiece, and/or any coupled component machines 500, or other applicable component. The static support 114 reduces pressure on the actuating support 112 and/or possibly any other components, and reduces stress on other components of the machine. With no moving parts, the static support 114 may be preferably sturdier and cheaper than an actuating support 112, making a static support 114 both easier to produce and maintain as compare to the actuating support 112. The static support 114 can be produced from any material as long as it can accomplish its support function. As seen in FIG. 4, in some preferred implementations, the static support foot 114 may be shaped like an arch, functioning as a support fulcrum and allowing actuating supports 112 on one side, or both sides, of the static support 114 to alter the angular orientation of the workpiece as per a seesaw motion.

The workpiece interface 130 of a preferred embodiment is a component of the leveling device 100. The workpiece interface 130 may be some general orientable platform or orientable object of appropriate type that is set up on a machining base 200. The workpiece interface 130 functions as an orientable surface that may be worked upon or used to mount machining tools, such as a rail system, mill, etc.

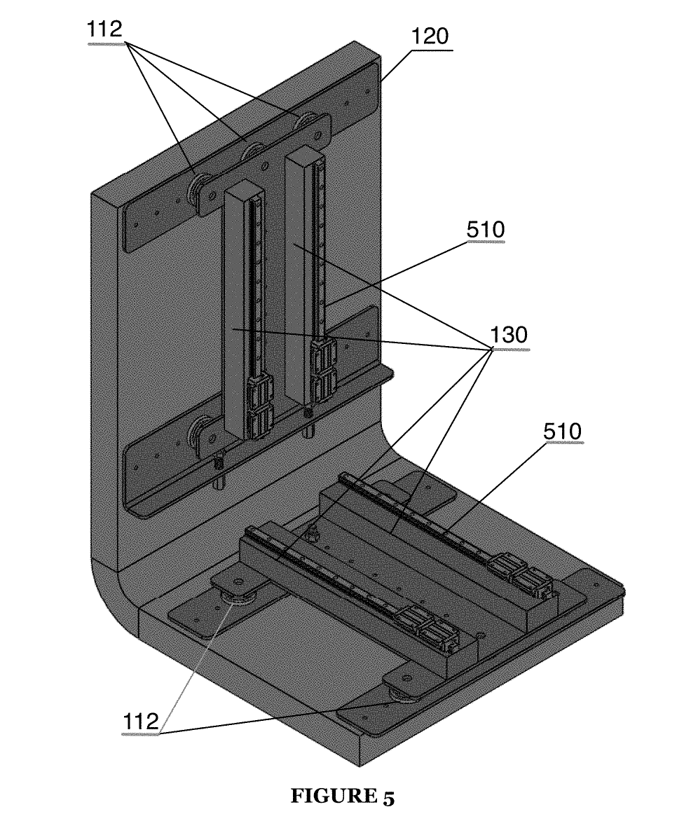

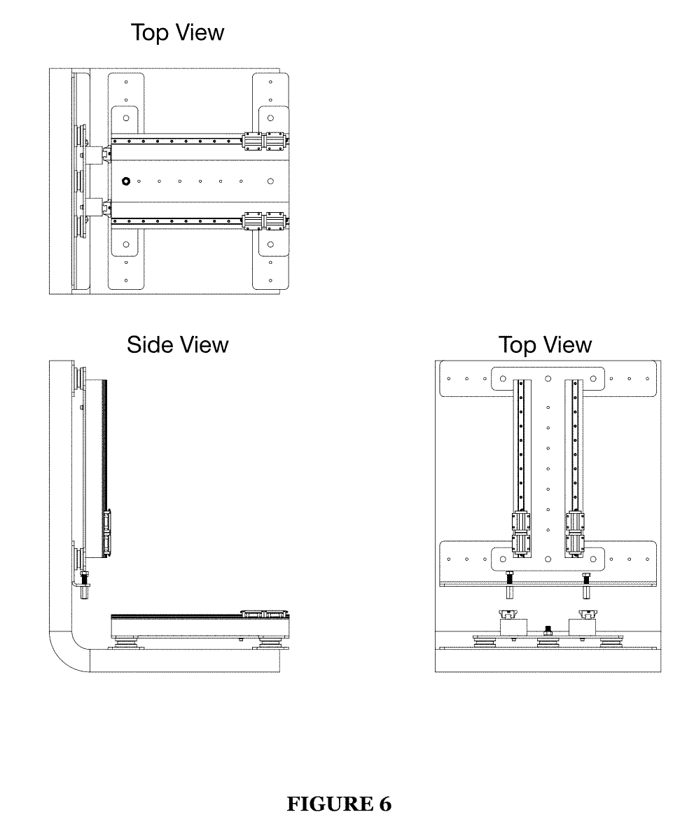

In a preferred implementation, the workpiece interface 130 is connected to the support system no. As long as the workpiece interface 130 is sufficiently stable, the workpiece interface 130 may be connected to the support system no in any desirable fashion, e.g. the workpiece interface 130 may be bolted, glued, locked, or even just sitting on top of the support system no. Similar to the machine base interface 120, in one preferred example the workpiece interface 130 may be a mounting plate used to couple the workpiece to the support system no. The mounting plate preferably includes a number of fixture mechanisms where the mounting plate can be attached to the workpiece and/or a machining tool. The mounting plate may additionally include a number of actuating support 112 fixturing mechanisms to mount the support system no to the workpiece interface 130. The size, shape, and location of the base and support fixture mechanisms may be adjusted and customized for the particular use case and/or type of machine. The workpiece interface 130 may alternatively take other forms as seen necessary. As seen in FIG. 5 and FIG. 6, in one preferred example, the workpiece interface 130 is a planar surface with an attached rail system 510. The workpiece interface 130 may alternatively be a block attached to a machining tool, a mill, a robot arm, or any other machining object.

Actuation of the actuating supports 112 may collectively adjust or orient the workpiece interface 130 with respect to the machine base interface 120 or any other suitable point of orientation. For the example of a planar workpiece interface 130 with an attached rail system 510, the leveling device 100 has two degrees of freedom for orientation, i.e. the two planar angles of the workpiece. Actuation of the support system 110 can alter the orientation of the workpiece interface 130, thereby altering the orientation of the rail system 510. By allowing all actuating supports 112 to lengthen or shorten, the rail system 510 may have an additional degree of freedom. For example, the height with respect to the machine base 200 may be adjustable. Depending on the implemented supports in the support system no and implemented workpiece interface 130, the leveling device 100 may have additional and/or alternative degrees of freedom. Examples include, but are not limited to, rotation of the planar base, bending of joints for a robot, displacement of milling tools, etc. The degrees of freedom incorporated into the manufacturing machine by the leveling device 100 may allow for routine adjustments and calibrations to take place wherein this possibility is not commonly occurring for manufacturing machines in existence today. For example, a rail system 510 may be routinely aligned, or a machining tool may be calibrated such that they can both tool and rail system function properly, and more optimally than prior to adjustment.

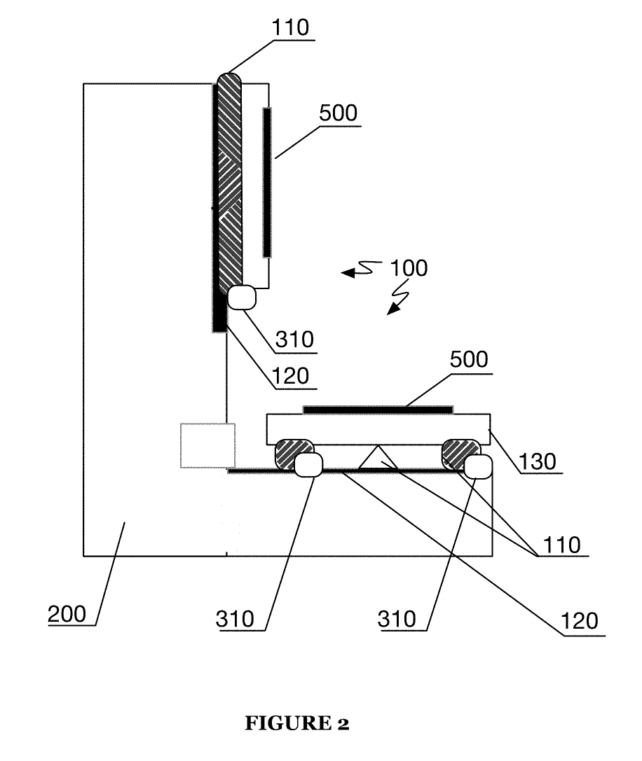

As shown in FIG. 2, in some implementations the system may have a second leveling device 100. A second leveling device 100 may introduce additional degrees of freedom. For example, the second leveling device 100 may introduce two or more degrees of freedom such as two planar angles of orientation and optionally workpiece interface “height” with respect to the machine base interface 120 of the second leveling device 100. The system may alternatively have more than two leveling devices 100. Each leveling device 100 would introduce a new set of degrees of freedom that the manufacturing machine may adjust. In some preferred example the second leveling device 100 is substantially orthogonal to the 1st leveling device 100 and connected to the same base interface 200 such as in the variation shown in FIG. 2. A preferred implementation would be a machine base 200 with orthogonal leveling devices 100 and a rail system 510 attached to each workpiece interface 130 as shown in FIG. 5. In this implementation, calibration may require adjusting both sets of rails to keep them orthogonal with respect to each other and a specific distance apart. In another variation, a machining tool may be coupled to the workpiece interface 130 of a first leveling device 100 and a rail system 510 may be coupled to the workpiece interface 130 of a second leveling device 100. Alternatively, any suitable machine components may be mounted in any suitable combination to the two or more leveling devices 100 of a machine. Some implementations include a manufacturing machine with multiple rail systems, or a multi-jointed robot arm.

A calibration system 300 of a preferred embodiment is a component of the manufacturing machine. The calibration system 300 functions to detect a calibrated state of the system and then to monitor the system over time. The calibration system 300 comprises of orientation sensors 310. The calibration system 300 may additionally include or interface with a control system 400.

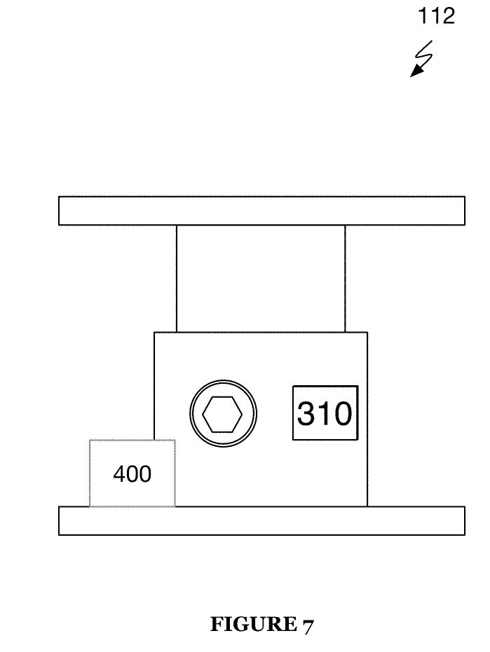

Orientation sensors 310 are preferably components of the calibration system 300. Orientation sensors 310 may function to detect and report on conditions of the alignment of the system. The orientation sensors 310 can preferably sense the angle and/or relative orientation of specific components, which then can relate to the orientation of the leveling device 100. Each sensor 310 could be a multi-axis accelerometer, gyroscope, level, optic sensor and/or any relevant sensor. A set of different types of sensors may be used. The orientation sensors 310 may be located or integrated into any component of the system depending on the type of sensor. As examples of possible (but not an exhaustive) locations, the orientation sensors could be positioned on coupled components 500 to the workpiece interface as shown in FIG. 1, on parts of the support system 110 as shown in FIG. 2, and/or on the workpiece interface 130 as shown in FIG. 3. As seen in FIG. 7, one preferred example is an orientation sensor 310 integrated into each actuating support 112. These actuating support sensors 310 may measure the actuation of each actuating support 112. These support sensors 310, as a whole (either alone or with the help of other orientation sensors 310), may then determine the workpiece interface orientation. One alternative example would be level sensors 310 attached alongside the workpiece interface 130 and the base interface 110. Level sensors 310 placed on the side of the base interface 110 and workpiece interface 130 would respectively determine the angle of the base interface 110 and workpiece interface 130 with respect to gravity along the axis of the level. Measurements from both base interface levels and workpiece interface levels would allow the determination of the workpiece interface orientation. An alternative example of a sensor 310 would be a laser attached to a machine arm that is situated across from the workpiece 130. The sensor 310 on the machine arm may then be used to measure orientation of the workpiece interface 130 by shining light along the workpiece interface 130. Measuring the diffraction of light along the workpiece interface 130 would then be used to calculate the workpiece orientation. This method may even allow measurement of flaws along workpiece 130 or machine surfaces.

The calibration system 300 could additionally include a control system 400 that functions to facilitate coordinating use of the actuating supports 112. The control system 400 can be used in reporting on the state of the alignment/calibration. The control system 400 can receive sensor data from each orientation sensor 310. The sensor data can be processed and translated into an alignment measurement. The alignment measurement can be any suitable characterization of the level. The alignment measurement may be based on absolute alignment relative to gravity or the base interface 120, but could alternatively be relative to another internal or external component of the system. For example, alignment measurement for multiple rail systems 510 could characterize the alignment of two rail systems that should be aligned along orthogonal planes.

The control system 400 may just provide necessary information for a worker to manually adjust each actuating support 112. Alternatively, the control system 400, when used in combination with a computer controlled variation of actuating supports 112, can additionally be used in directly adjusting the actuation state of the actuating supports 112. Such computer control can be coordinated between actuating supports 112 to orient a workpiece interface 130 along all degrees of freedom. In addition, actuating supports 112 for distinct leveling devices 100, can also be coordinated (e.g. as per the two level system) for a computer controlled system. The control system 400 and optionally by extension the calibration system 300 can additionally include an interface with or be integrated into a machine control system (e.g., a control system of a CNC machine). The control system 400 can then coordinate calibration and manipulation of the workpiece interface 130 with the machining process. For example, calibration could be dynamically adjusted for different cutting processes. Calibration could similarly be performed at certain times based on state of the machining (e.g., before or after a cutting routine). In one particular variation, the control system of a CNC machine could coordinate the calibration with the scheduling and performance of various machining jobs. Calibration could be performed automatically before or during initialization of a job, upon completing a job, or even during the execution or an interim stage of a job. Here job refers to exemplary processes such as a series of CNC instructions for machining a part, but could alternatively be any process of the machine.

The rail system is a preferable example of the workpiece involved in translating material and/or a piece of tooling during use. Schematics of the rail system are shown in FIG. 5 and FIG. 6. The rail system 510 can be mounted to the support system 110 through a mounting plate workpiece interface 130. In a similar manner a mounting plate base interface 120 physically couples the machine base 200 to the support system 110. A set of actuating supports 112 may be positioned under the rail system 510 at both ends of the rail. Three actuating supports 112 may be implemented per end, but fewer or more may be implemented as necessary. Due to weight and stability of the rail system 510, additional actuating supports 112, or even static supports 114 may also be implemented. In some instances, the rail system 510 is used for manipulating material being processed. In another instance, the rail system 510 is used in manipulating tooling used in machine operations. The rail system 510 in many cases can use computer control and/or manual control of translation across one or more axis.

In some implementations, the system includes coordinated operation of actuating supports 112 used in calibrating two or more rail systems 510 on a machine base interface 120. For example, a first set of actuating supports 112 can be used with a two-axis rail system 510 used for moving material horizontally, and a second set of actuating supports 112 used with a single axis rail system 510 for vertical translation of tooling. In a general example, the two rail systems 510 are preferably substantially aligned along two perpendicular planes. The two or more rail systems 510 may alternatively be aligned along non-parallel planes. In some cases, the system may be used where the alignment may change at different stages of machine operation. The system can be used in aligning relative orientation of two or more planes.

### 3. Method

A method of calibrating for manufacturing of a preferred embodiment can facilitate enhanced calibration of a manufacturing machine that uses a system such as the one described above.

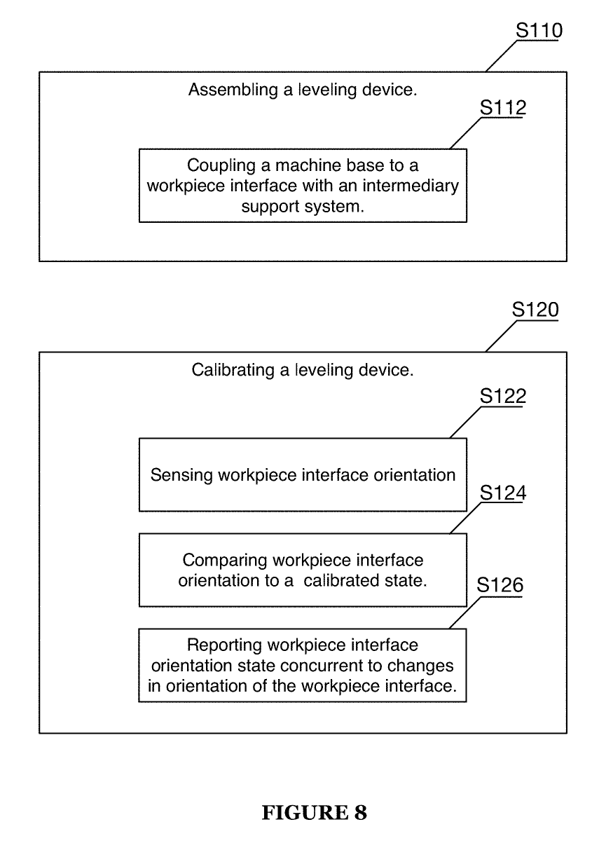

The method can be applied in the case where the calibration system is manually controlled, as shown in FIG. 8, wherein the method can include assembling a leveling device S110 and calibrating a leveling device S120. Assembling a leveling device S110 can include coupling a machine base to a workpiece interface with an intermediary support system S112. Calibrating a leveling device S120 can include: sensing workpiece interface orientation S122, comparing workpiece interface orientation to a calibrated state of the system S124, and reporting workpiece interface orientation state concurrent to changes in orientation of the workpiece interface S126. This method may additionally be applied to an automated system, or applied when communicating a calibration state is desirable. In some variation, wherein the system is computer monitored but manually controlled, the method can generate instructions such that a machine worker can more efficiently calibrate a machine. In traditional calibration, there is a long process of iteratively making small adjustments. The method described herein may provide indicators that can guide during the calibration process which may simplify such a time consuming process—through reported directions, each actuating support could be directly set to an appropriate setting to achieve a calibrated state. The method described herein may additionally simplify the process by providing iterative and/or “real time” feedback about the current state of calibration. For a system that is monitored by a computer, but still manual calibration is desired, or required, providing feedback may additionally provide “real time” directives to calibrate the system, allow workers to intercede on the automated process, and potentially add a level of redundancy to reduce errors. Additionally, reporting can signal to a user when the machine needs calibration.

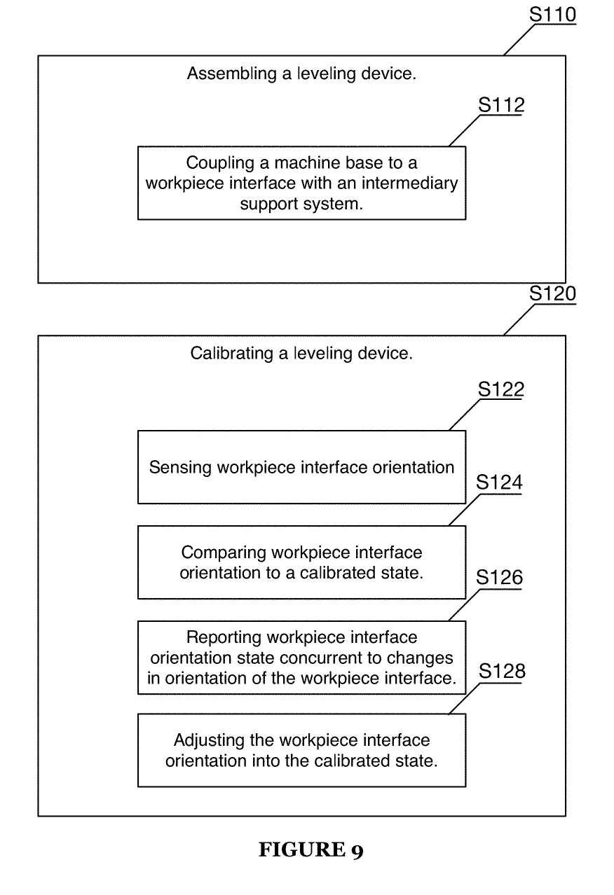

The method could further be applied in the case where the system is automated as shown in FIG. 9, wherein the method can include assembling a leveling device S110 and calibrating a leveling device S120, wherein block S120 comprises of additional subcomponents. Thus, the method of automated calibrating for a manufacturing machine comprises: assembling a leveling device S110, comprising coupling a machine base to a workpiece interface with an intermediary support system S112; and calibrating a leveling device S120, comprising sensing workpiece interface orientation S122, comparing workpiece interface orientation to a calibrated state of the system S124, reporting workpiece interface orientation state concurrent to changes in the orientation of the workpiece interface S126, and adjusting the workpiece interface orientation to a calibrated state S128. Automated calibration can have numerous applications, and may preferably be computer controlled. Automated calibration can be used in automatic calibration on machine startup or shutdown. Computer controlled calibration can be used in dynamic real-time calibration. In some variations, the machine may be dynamically adjusted to accommodate for current machine usage. Calibration will typically include adjusting the actuating support to a particular position. The method may additionally or alternatively use active calibration where an actuation signal is applied so that the position is modified as a function of time.

Block S110, of a preferred embodiment, which preferably includes assembling a leveling device, functions to assemble a moving leveling device. The leveling device allows for routine calibration of the machine by supplying an adjustable component into the system, i.e. an actuating support system. Assembling the leveling device S110 of a manufacturing machine may occur when a new manufacturing machine is built but may also occur during maintenance or repair of the machine. In some preferred variation, assembling a leveling device may be used to retrofit a manufacturing machine that does not have a leveling device. As most existing manufacturing machines do not include a leveling device and were not originally designed with one in mind, the machine may be taken apart first and then refit, by assembling a new leveling device for the machine. In addition to coupling the subcomponents of a leveling device, retrofitting a manufacturing machine can additionally include building or providing new subcomponents (e.g. providing a workpiece, actuating supports, etc.) to couple to some previously existing subcomponents (e.g. a base). Depending on the condition of the machine, additional steps may also be necessary to properly retrofitting the machine.

In some variations, block S110, assembling a leveling device may further comprise of assembling a machine base by combining modular blocks. Modular blocks as a whole function as a stable machine base that is easier and cheaper to assemble than a metal cast machine base. Assembling a machine base may comprise of attaching individual modular blocks together to form the shape of the desired machine base. Blocks may be fastened by bolting, or through other alternative means that produces a stable machine base. One or more leveling devices may be coupled to the modular block machine base. In some variations, a modular block base approach may be susceptible to introduction of mis-alignment through use of the machine. Accordingly, the process of calibration the leveling device may be performed more regularly with the operation of the machine or during a settlement period for example.

Block S112, which includes coupling a machine base to a workpiece interface with an intermediary support system, functions to combine and connect the parts of a leveling device and place the system in an “initial” calibrated state. The support system is comprised of actuating supports that adjust the workpiece interface with respect to the base and other components within and outside of the system. Depending on the type of manufacturing machine, type of operations the machine will be used for, and potential alternative factors, methods for coupling the workpiece interface to the base by a support system may change. In the preferred example of a workpiece interface coupled to a rail system, coupling the base to workpiece interface may include bolting both the base and the workpiece interface to the intermediary actuating support feet. In addition, for a rail system, the support system may be comprised of three actuating supports at two ends of the workpiece interface coupling to the base and workpiece interface. Alternative methods for coupling of the base to the workpiece interface, such as welding, gluing, imprinting into each other, or even just placing them on top of each other, may additionally or alternatively be used as seen fit for the mode of operation of the machine.

For the variation of retrofitting a manufacturing machine, assembling the leveling device, block S110, may additionally require removing connected machining tools and/or any other objects that may hinder assembling the leveling device. An appropriate support system and workpiece interface can then be coupled to the base, S112. Additional components from the initial machine and workpiece interface, if appropriate, may still be reused on a retrofit machine.

In one preferred variation, the method of calibration is applied to assembling two leveling devices, that is block S110 comprises of building two leveling devices and S120 comprises of calibrating both leveling devices. These two leveling devices are preferably of the same machine and may be coupled together, but could alternatively be leveling devices of different, distinct machines. Alternatively, additional leveling devices may be added as necessary or desired.

Block S120, which includes calibrating a leveling device, functions to determine and assist in the alignment of the leveling device. Block S120 can operate as several subprocesses that include sensing the workpiece interface orientation S122, comparing the orientation to a calibrated state S124, and reporting the workpiece interface orientation state S126. For an automated system, block S120 can additionally include adjusting the workpiece interface orientation such that the system is in a calibrated state S128, and thus further increasing the functionality, of block S120, to adjust alignment of the leveling device for precise machine operation.

Block S122, which includes sensing workpiece interface orientation, functions to measure the orientation of a workpiece interface. Sensing workpiece orientation may be with respect to a part of the machine or leveling system, such as the machine base, could alternatively be with respect to external objects, or alternatively the sensing workpiece orientation could be with respect to absolute quantities, such as the direction of gravity. Sensing workpiece interface orientation can include measuring angular orientation using a multi-axis accelerometer and/or gyroscope. Alternatively, workpiece interface orientation may be measured by a level sensor located on the workpiece. Alternatively workpiece orientation may be determined by remotely sensing working interface orientation. Optical sensing, displacement sensing, and/or other techniques may be used for remote sensing. For example, laser refraction off the workpiece surface can be used to sense the workpiece interface orientation. In some variations, the sensing of the workpiece interface orientation indirectly senses the orientation of a workpiece interface component, wherein sensing includes directly sensing orientation of a component coupled to the workpiece interface component. For example, the top surface of a rail system can be sensed and used to indirectly infer the orientation of the workpiece interface orientation. In another variation, the sensing of the workpiece interface orientation may directly sense a surface of the workpiece interface to which a component is mounted. Additional or alternative methods may be used in sensing workpiece orientation. In a preferred implementation the workpiece orientation is measured at multiple locations along the workpiece. In one implementation, orientation sensors are integrated directly into each actuating support measuring the actuation of each actuating support. In this implementation, orientation data can be collected from each actuating support individually and combined. Other sensing approaches could alternatively be used, and methods for sensing may be changed as necessary. When multiple sensors are determining orientation at different points, those different data inputs could be processed and modeled to reflect the resulting orientation of the workpiece interface.

The orientation data can be sampled at a distinct time. Alternatively, orientation data could be read as a data stream so that real-time calibration reporting and adjustments may be made.

Block S124, which includes comparing workpiece interface orientation to a calibrated state, functions to process orientation data and analyze how the current state matches with a desired alignment. The calibrated state could be an absolute orientation that is recorded and then used as a reference. For example, workpiece orientation may be compared to a theoretically flat orientation relative to an absolute orientation. The calibrated state is more preferably a relative orientation, wherein the relative orientation is of the workpiece interface to another element with variable orientation (e.g. For a system with two rail systems each attached to a workpiece, calibration of a workpiece interface may be determined with respect to the other workpiece interface).

In addition, or alternatively, to sensor data from other locations on the machine, the actuation position of the actuating supports could be measured or sensed and used in modeling the workpiece interface orientation to a calibrated state. Sensor data may allow for additional parameters of orientation as compared to some other sensors. For example, actuating support sensors may allow sensing and determining the height of the workpiece interface. Actuating support sensors may also allow for easier manual calibration since a worker may be able to directly read the length of actuation of the actuating support. Actuating support sensors alone, as a group of support sensors may be used to determine the workpiece orientation, but may also work in conjunction with any other type of sensor.

Block S126, which includes reporting workpiece orientation state concurrent to changes in orientation of the workpiece interface, functions to communicate and inform about the current state of calibration. Block S126 may additionally or alternatively provide calibration directives and/or warnings. The report is preferably used in presenting information through a user interface output (possibly integrated with the actuating supports). In one implementation, Block S126 assesses the calibration state and can determine predicted/modeled adjustments to achieve a calibrated state, and then instructions can be presented on how to adjust the actuating supports. This could be particularly useful in a system that is not computer controlled and relies on manual calibration. For example, a manually actuated system could display an actuation position for each actuating support to achieve a desired calibration state. The user without performing any measurements can simply manipulate the actuating supports to the specified position. These data may be presented in real time, such that while the user makes minor changes, the displayed information updates measurements and directive information. An example of this variation may be for a computer monitored system where the supports are manually actuated. After, and during, incremental adjustments made by a worker, the system can provide feedback of the current state of calibration and potentially advice the worker which actuating support and how much it should be adjusted. As another addition, the method could additionally include receiving machine state, which functions to access information on the operations and state of the machine. Additionally or alternatively, reporting information and directives may not occur through a visual display. For an automated calibrating machine, reporting may occur directly to the computer, or other device, that is controlling the system so adjustments can be made.

Additionally, the method may allow reporting the machine status and history. This may include reporting, e.g. “machine in use”, but may additionally report previous operations that the machine has undergone, errors, malfunctions, or other information of interest. Reporting calibration directives can relate to issuing a calibration limit alert. In some cases, a machine may degrade beyond the capabilities for the calibration system. The method could include alerting a user to approaching such a state and/or when such a state is reached. In one variation, if the rail system goes beyond a threshold, the system could direct the machine system to alter a process to address calibration. For example, a directive could be transmitted to halt a machining process at the next opportunity so that calibration could be performed. Similarly, such calibration warnings may be used to identify when a machine process should be aborted. Machine state could additionally include operation instructions, which could include CNC instructions. The machine state information can be used in assessing the impact of a machine operation.

Block S128, which includes adjusting a workpiece interface orientation to the calibrated state, functions to alter the state of a set of actuating supports that can affect the orientation of the workpiece interface. Actuating supports may be actuated in conjunction with each other or independently. During calibration, at least a subset of actuating supports can be directed to actuate to a new position. In some variations, the calibration process may be iterative such that the sensed orientation can be monitored in real-time and used in a feedback to achieve a calibrated state.

The actuating supports can be actuated at any suitable time. In one variation, calibration can be part of the machine initialization and/or deactivation process. Alternatively, calibration can be used during machine operation. In one variation, calibration can be coordinated with machine operation such that calibration can be performed at appropriate moments. In one implementation, a calibration directive could be included within a CNC directive set so that a user could specify when calibration is desired. In another variation, calibration and actuation of the actuating supports can be applied during active machine use (e.g., during cutting). In some implementations, actuation can be based on an actuation signal, which may function to apply active dampening to vibrational effects of a machine. That is, sensor information may be received continuously, and once the machine has reached some tolerance or skewness, the machine may directly start adjusting to compensate, even during normal function. In some variation, the machine may have multiple calibration states depending on the mode of operation. In some implementation of a milling machine, altering calibration of a milling machine may allow cutting at different angles allowing for greater modes of operation.

The actuating supports are preferably moved to a static position that is to be held until another calibration event. The calibrated state will generally be one that achieves a target orientation. In one variation, however, the method could include biasing calibration. Biasing calibration may be used in predictively adjusting the orientation for an upcoming or predicted machine operation. Prior to starting a particular machine process, the method could automatically actuate to a biased calibration state (e.g., deliberately calibrate to an orientation outside a calibration target), which may function to enable the machine achieve some performance gains when performing the machine process. The calibration impact of a particular process could be learned through data analysis. For example, when a machine is repeatedly used for the same manufacturing process, the calibration impact can be learned and then used to customize calibration for that particular manufacturing process. Such predictive calibration could additionally be extended or be applied to other manufacturing operations with similar properties.

The systems and methods of the embodiments can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

We claim:

1. A system for calibrating a manufacturing machine comprising:
a leveling device that comprises:
a machine base interface to a manufacturing machine,
a support system that comprises of a set of linearly actuating supports,
a workpiece interface, and
wherein actuation of supports collectively adjusts the orientation of the workpiece interface with two degrees of angular freedom; and a
calibration system with sensors configured to measure the orientation of the workpiece interface.

2. The system of claim 1, wherein the orientation of the leveling device further has additional degrees of freedom that can be adjusted by actuation of the support system.

3. The system of claim 2, wherein the additional degrees of freedom is further comprised of the height of the workpiece interface.

4. The system of claim 1, further comprising of a second leveling device, wherein the orientation of the workpiece interface is measured by the calibration system relative to a second workpiece interface of the second leveling device.

5. The system of claim 1, wherein the support system further comprises at least one static support.

6. The system of claim 1, wherein the support system is comprised of at least three actuating supports in linear arrangement on at least two ends of the support system.

7. The system of claim 1, wherein the calibration system is further comprised of sensors to measure the actuation of each actuating support.

8. The system of claim 1, wherein the workpiece interface is coupled to a machining tool.

9. The system of claim 1, wherein the workpiece interface is coupled to a rail system.

10. The system of claim 1, wherein actuation of the actuating support is manually controlled.

11. The system of claim 1, wherein actuation of the actuating support is machine controlled.

12. The system of claim 11, wherein the calibration system further comprises of a control system that autonomously controls the actuating support.

13. The system of claim 12, wherein the calibration system is integrated into a control system of a computer numerical control machine.

14. The system of claim 1, further comprising a machine base, wherein the machine base interface couples to the machine base.

15. The system of claim 14, wherein the machine base is comprised of modular blocks.

16. A method of calibrating for a manufacturing machine comprising:
assembling a leveling device comprising of:
coupling a machine base to a workpiece interface with an intermediary support system.
calibrating the leveling device comprising of:
sensing workpiece interface orientation,
comparing workpiece interface orientation to a calibrated state, and
reporting workpiece interface orientation state concurrent to changes in the orientation of the workpiece interface.

17. The method of claim 16, wherein calibrating the leveling device further comprises of adjusting the workpiece interface orientation with a set of actuating supports.

18. The method of claim 16, wherein calibrating the leveling device is performed in coordination with the operation of the machine.

19. The method of claim 16, wherein assembling a leveling device further comprises of assembling a second leveling device, wherein calibrating is further applied to both leveling devices.

20. The method of claim 16, wherein assembling a leveling device further comprises of assembling a machine base of modular blocks, wherein the leveling device is coupled to the machine base.
